(19) United States
(12) Patent Application Publication
(10) Pub. No.: US 2026/0296070 A1
(43) Pub. Date: Oct. 1, 2026

(54) MEDIUM LOADING DEVICE, FEEDING DEVICE, IMAGE READING DEVICE, AND IMAGE FORMING DEVICE

(71) Applicant: SEIKO EPSON CORPORATION, TOKYO (JP)

(72) Inventor: Hiroyuki TAJIMA, KITAKYUSHU-SHI (JP)

(21) Appl. No.: 19/577,459

(22) Filed: Mar. 25, 2026

(30) Foreign Application Priority Data
Mar. 26, 2025 (JP) 2025-051232

(51) Int. Cl. B41J 13/30; B41J 3/46; B41J 11/00; B41J 13/00; B41J 13/10; H04N 1/00

(52) U.S. Cl. CPC B41J 13/30; B41J 3/46; B41J 11/003; B41J 13/0018; B41J 13/103; H04N 1/00615; H04N 1/0066; H04N 1/00708; H04N 1/00771; H04N 2201/0081

(57) ABSTRACT

A medium loading device includes a first regulating part and the second regulating part configured to be able to adjust a position of a medium placed on a placement part, and an interlocking mechanism interlocking with the first regulating part and the second regulating part, and the interlocking mechanism includes a first rack part, a second rack part, a first pinion gear, a second pinion gear, an energizing part, a first rotating part, and a second rotating part, and when the second regulating part is fixed and the first regulating part is moved in a width direction, the second pinion gear stops, the first pinion gear rotates, and the first rotating part, the second rotating part, and the energizing part rotate or stop in a unified manner.

### CROSS-REFERENCE TO RELATED APPLICATION

The present application is based on, and claims priority from JP Application Serial Number 2025-051232, filed Mar. 26, 2025, the disclosure of which is hereby incorporated by reference herein in its entirety.

### BACKGROUND

### 1. Technical Field

The present disclosure relates to a medium loading device, a feeding device, an image reading device, and an image forming device.

### 2. Related Art

JP-A-2009-292541 describes a paper feed tray including a pair of sheet guides in which the space between the sheet guides is adjustable according to the width of a sheet, and an interlocking mechanism that interlocks the pair of sheet guides so as to move in opposite directions by the same amount. The interlocking mechanism includes a pair of racks that move together with the respective sheet guides, and a pair of pinions that mesh with the respective racks. The pair of pinions are coaxially provided with a friction pad interposed therebetween, and are pressed against the friction pad by a spring. In this paper feed tray, when an external force is applied to one of the pair of sheet guides, the pair of pinions are brought into a synchronous state by the frictional force of the friction pad, and the pair of sheet guides operate in an interlocking manner with each other. Meanwhile, when an external force against the synchronous state is applied to both of the sheet guides, the pair of pinions are brought into an asynchronous state, and the pair of sheet guides operate in a non-interlocking manner with each other. With this configuration, switching can be made between a state where the sheet guides guide a sheet at the center in the width direction of the paper feed tray and a state where the sheet guides guide a sheet at one end in the width direction of the paper feed tray.

JP-A-2009-292541 is an example of the related art.

However, in the configuration as described above, when the pinions rotate with the movement of the sheet guides, the spring may be twisted. In this case, even when the sheet guides are moved in accordance with the end parts of the sheet, the twisted spring is to return and therefore the sheet guides move. That is, in the configuration described in JP-A-2009-292541, it is difficult to align the position of the sheet guides with a desired position.

### SUMMARY

According to an aspect of the present disclosure, a medium loading device includes: a placement part where a medium is placed; a first regulating part and a second regulating part configured to be able to adjust a position of the medium placed on the placement part in a width direction intersecting a feeding direction of the medium; and an interlocking mechanism configured to move the first regulating part and the second regulating part in an interlocking manner, and the interlocking mechanism includes: a first rack part coupled to the first regulating part; a second rack part coupled to the second regulating part; a first pinion gear meshing with the first rack part; a second pinion gear disposed in a first direction of the first pinion gear and meshing with the second rack part; an energizing part configured to energize the first pinion gear and the second pinion gear in a direction away from each other along the first direction; a first rotating part located between the first pinion gear and the energizing part in the first direction and configured to be rotatable together with the energizing part; and a second rotating part located between the second pinion gear and the energizing part in the first direction and configured to be rotatable together with the energizing part, and when the second regulating part is fixed and the first regulating part is moved in the width direction, the second pinion gear stops, the first pinion gear rotates, and the first rotating part, the second rotating part, and the energizing part rotate or stop in a unified manner.

A feeding device includes: the medium loading device; and a feeding unit configured to feed the medium loaded in the medium loading device, and when viewed from the feeding direction, the feeding unit is located between the first regulating part and the second regulating part, and a center position between the first regulating part and the second regulating part that are in contact with the medium and a center position of the feeding unit do overlap each other.

An image reading device includes: the feeding device; and a reading unit configured to read an image on the medium fed by the feeding device.

An image forming device includes: the feeding device; and a recording unit configured to perform recording on the medium fed by the feeding device.

### BRIEF DESCRIPTION OF THE DRAWINGS

FIG. 1 is an external perspective view of an image reading device.

FIG. 2 shows the configuration of the image reading device.

FIG. 3 is a perspective view showing the configuration of a placement part.

FIG. 4 illustrates the operation of a fixing part.

FIG. 5 is a cross-sectional view showing the configuration of an interlocking mechanism.

FIG. 6 is a perspective view showing the configuration of a first rotating part, a second rotating part, and an energizing part.

FIG. 7 is a plan view illustrating the configuration of a feeding unit.

FIG. 8 is a plan view illustrating the configuration of the feeding unit.

### DESCRIPTION OF EMBODIMENTS

The present disclosure will be specifically described below. An X-Y-Z coordinate system shown in the drawings is an orthogonal coordinate system in which a direction indicated by an arrow is a + direction and a direction opposite to the + direction is a - direction. An X-axis direction is a direction intersecting the feeding direction of a medium P, that is, the width direction of the medium P, and is the width direction of the device. A Y-axis direction is the depth direction of the device. Along the Y-axis direction, a +Y direction is a direction from the back surface of the device toward the front surface of the device, and a -Y direction is a direction from the front surface of the device toward the back surface of the device. A Z-axis direction is a vertical direction and is the height direction of the device. Along the Z-axis direction, a +Z direction is an upward direction, and a -Z direction is a downward direction.

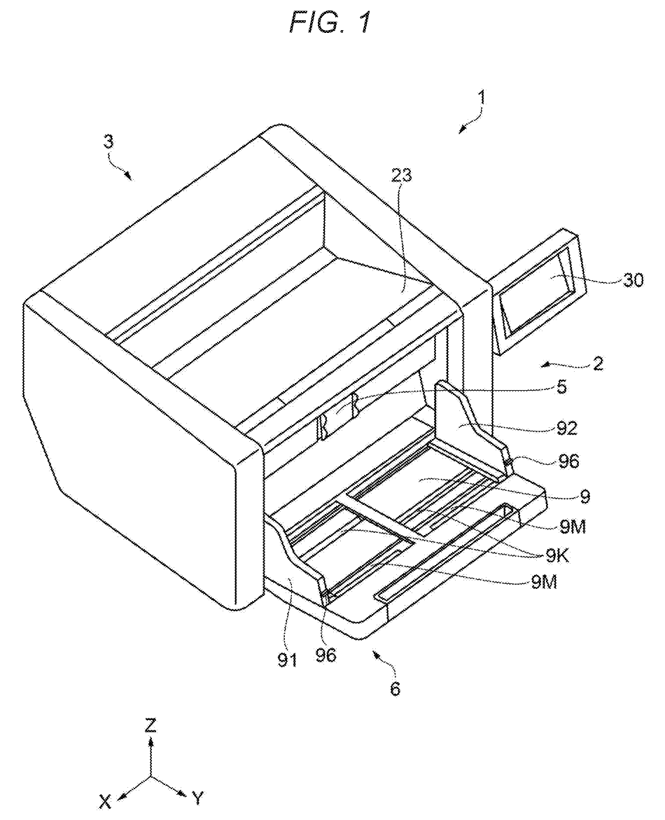

As illustrated in FIGS. 1 to 3, an image reading device 1 according to the present embodiment is a scanner that can read an image on the medium P, and is a sheet-feed-type scanner that reads an image on the medium P while feeding the medium P. Here, the image on the medium P refers to an image visually recorded on the medium P, and is, for example, a character, a geometric shape, a table, a picture, a photograph or the like.

The image reading device 1 includes a medium loading device 6, a pick roller 11, a feeding roller 12, a separation roller 13, an upstream feeding roller pair 15, a downstream feeding roller pair 16, an upstream reversing roller pair 17, an intermediate reversing roller pair 18, a downstream reversing roller pair 19, a paper discharge roller pair 20, and a discharge receiving part 23. These parts are arranged in this order along a feeding path T. The image reading device 1 also includes a housing 3 serving as an exterior of the image reading device 1, a display unit 30 that displays an operation status of the image reading device 1 and accepts an input operation via a touch panel, and a control unit 4.

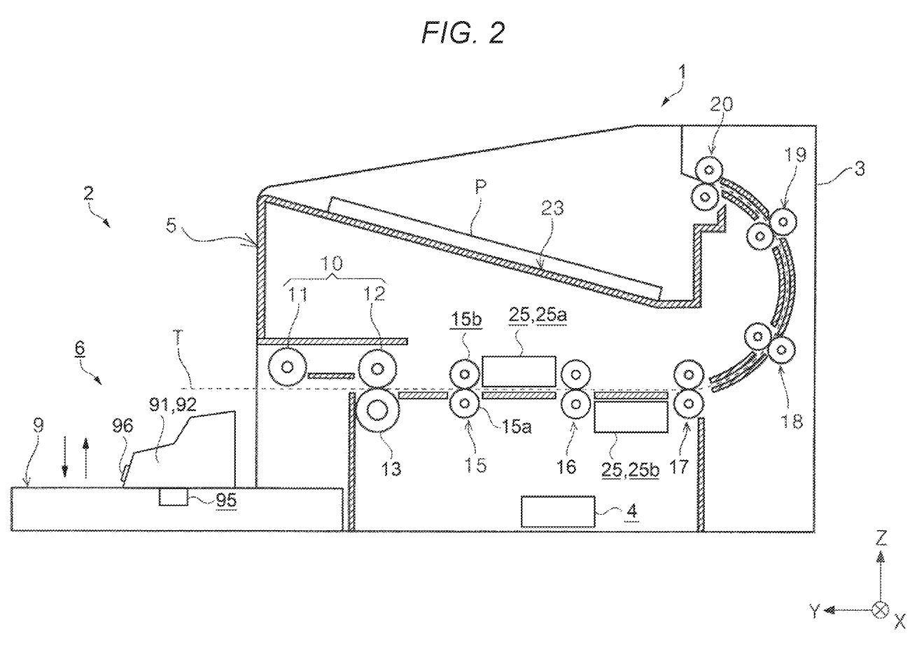

The feeding path T is formed inside the housing 3. In FIG. 2, the feeding path T is indicated by a broken line. In the feeding path T, the medium P is linearly fed along the -Y direction, then reversed upward, and discharged in the +Y direction. The configuration around the feeding path T will be described below along the direction in which the medium P is fed. In the description below, the direction in which the medium P is fed may be referred to as "downstream", and the opposite direction may be referred to as "upstream".

The medium loading device 6 in which the medium P is loaded is provided at the most upstream part of the feeding path T. The medium loading device 6 includes a placement part 9 that supports the medium P, a first regulating part 91 and a second regulating part 92 that can regulate and adjust the position of the medium P in the width direction thereof, and an interlocking mechanism 95 that moves the first regulating part 91 and the second regulating part 92 in an interlocking manner. Details of the first regulating part 91, the second regulating part 92, and the interlocking mechanism 95 will be described later.

The placement part 9 horizontally supports the medium P. Of course, the placement part 9 may support the medium P in an inclined posture. The placement part 9 is lifted and lowered along the vertical direction while maintaining the posture thereof by a power source, not illustrated. When the placement part 9 is raised, the medium P supported by the placement part 9 can come into contact with the pick roller 11.

The pick roller 11 is driven by a motor, not illustrated, and feeds downstream the medium P supported by the placement part 9. The feeding roller 12 is provided downstream of the pick roller 11 in the feeding path T. The feeding roller 12 is driven by a motor, not illustrated, and feeds the medium P downstream. The pick roller 11 and the feeding roller 12 form a feeding unit 10 that feeds the medium P from the placement part 9. The medium loading device 6 and the feeding unit 10 form a feeding device 2.

The separation roller 13 is provided at a position facing the feeding roller 12. The separation roller 13 nips the medium P with the feeding roller 12 and thus separates the medium P. The separation roller 13 is driven by a motor, not illustrated, in a direction in which the medium P is returned upstream. A torque limiter, not illustrated, is interposed in a power transmission path between the separation roller 13 and the motor, not illustrated. When there is only one medium P between the feeding roller 12 and the separation roller 13, the separation roller 13 is driven to rotate in contact with the medium P by the action of the torque limiter. When there are a plurality of media P between the feeding roller 12 and the separation roller 13, the separation roller 13 rotates in the direction in which the medium P is returned upstream by the power of the motor, not illustrated, and thus multi-feed of the medium P is prevented. Instead of the separation roller 13, a separation pad may be employed. The pick roller 11, the feeding roller 12, and the separation roller 13 described above are provided at a center position in the width direction of the medium P or positions having bilateral symmetry with respect to the center position.

The upstream feeding roller pair 15 feeding the medium P downstream in the feeding direction is provided downstream of the feeding unit 10. The upstream feeding roller pair 15 is configured to be able to nip the medium P with an upstream feeding lower roller 15a and an upstream feeding upper roller 15b, and at least one roller is driven by a motor, not illustrated. The upstream feeding roller pair 15 feeds the medium P while nipping the medium P and therefore can feed the medium P downstream in the feeding path T in a stable state.

A reading unit 25 that reads an image on the medium P and the downstream feeding roller pair 16 are provided downstream of the upstream feeding roller pair 15. The reading unit 25 includes a first reading unit 25a and a second reading unit 25b. The first reading unit 25a and the second reading unit 25b are provided at positions shifted from each other in the feeding direction with the downstream feeding roller pair 16 interposed therebetween. The first reading unit 25a is provided above the feeding path T and reads an image on the upper surface of the medium P. The second reading unit 25b is provided below the feeding path T and reads an image on the lower surface of the medium P. Each of the first reading unit 25a and the second reading unit 25b includes, for example, a contact image sensor (CIS). Also, it is desirable that the upstream feeding roller pair 15 feeding the medium P while nipping the medium P is provided at a position upstream of and closer to the reading unit 25. Since the upstream feeding roller pair 15 is provided at a position upstream of and closer to the reading unit 25, the reading unit 25 can read the medium P in a stable feeding state.

The upstream reversing roller pair 17 is provided downstream of the reading unit 25 and the downstream feeding roller pair 16. In the feeding path T, a section from the pick roller 11 to the upstream reversing roller pair 17 extends horizontally. At least one roller of the upstream reversing roller pair 17 is driven by a motor, not illustrated. The upstream reversing roller pair 17 feeds the medium P downstream.

Downstream of the upstream reversing roller pair 17, the feeding path T is curved upward and reversed. In the curved and reversed section, the intermediate reversing roller pair 18, the downstream reversing roller pair 19, and the paper discharge roller pair 20 are provided downstream in this order. At least one roller of the intermediate reversing roller pair 18, the downstream reversing roller pair 19, and the paper discharge roller pair 20 is driven by a motor, not illustrated. The intermediate reversing roller pair 18 and the downstream reversing roller pair 19 feed the medium P downstream. The paper discharge roller pair 20 discharges the medium P in the +Y direction. The medium P discharged by the paper discharge roller pair 20 is supported by the discharge receiving part 23. The discharge receiving part 23 supports the medium P in an inclined posture. Of course, the discharge receiving part 23 may support the medium P in a horizontal posture.

A series of operations such as the lifting and lowering operation of the placement part 9, the rotation operation of each roller, the display and input acceptance of the display unit 30, and the image reading operation of the medium P by the first reading unit 25a and the second reading unit 25b are controlled by the control unit 4. The control unit 4 includes a CPU, a nonvolatile memory, and the like, not illustrated. Programs, parameters, and the like for performing various kinds of control are stored in the nonvolatile memory.

An opening-closing unit 5 is detachably provided in the housing 3. The opening-closing unit 5 forms a part of the feeding path T in a close state. The above-described discharge receiving part 23 is formed by the upper surface of the opening-closing unit 5.

The first regulating part 91 and the second regulating part 92 are flat plate-shaped members parallel to a Y-Z plane. At the top of the placement part 9, the first regulating part 91 is disposed on the +X side of the center in the width direction, and the second regulating part 92 is disposed on the -X side of the center in the width direction. The first regulating part 91 and the second regulating part 92 are movable in the width direction along the X axis according to the size of the medium P, on the upper surface of the placement part 9. Bottom parts of the first regulating part 91 and the second regulating part 92 are movably fitted into an elongated hole 9K provided in the placement part 9. The elongated hole 9K is a hole extending along the width direction of the placement part 9 and penetrates the placement part 9 in the up-down direction.

A first detection unit 911 that detects the position of the first regulating part 91 and a second detection unit 912 that detects the position of the second regulating part 92 are disposed at the placement part 9.

The first detection unit 911 and the second detection unit 912 are linear encoders. The first detector 911 and the second detector 912 are disposed at both ends in the X-axis direction of the placement part 9, detect the positions of the first regulating part 91 and the second regulating part 92, and output the detection results to the control unit 4.

The control unit 4 determines the size of the loaded medium P, based on the detection results of the first detection unit 911 and the second detection unit 912, and causes the display unit 30 to display the detection result of the determined size. With this configuration, since the medium loading device 6 detects the size of the medium P, based on the positions of the first detection unit 911 and the second detection unit 912, and causes the display unit 30 to display the size, the user can know the size of the medium P placed on the placement part 9. The first detection unit 911 and the second detection unit 912 are not limited to the linear encoder, and a laser sensor, a linear potentiometer, or the like may be used.

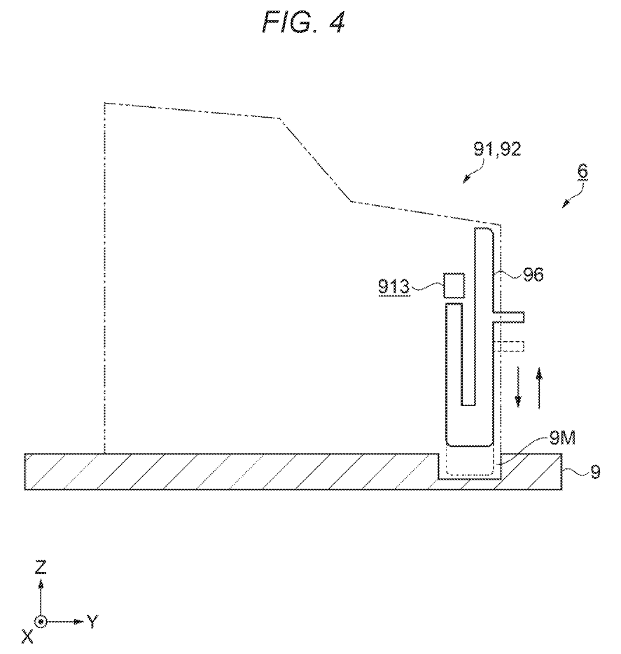

As shown in FIG. 4, the first regulating part 91 and the second regulating part 92 include fixing parts 96 that fix the first regulating part 91 and the second regulating part 92 to the placement part 9. The fixing parts 96 are held by the first regulating part 91 and the second regulating part 92 so as to be movable in the Z-axis direction. An engaging part 9M engageable with the bottom part of the fixing part 96 is formed at the upper surface of the placement part 9. In the engaging part 9M, a plurality of groove parts that are V-shaped when viewed from the Y-axis direction are formed in a serrated shape along the X-axis direction. The fixing part 96 slides in a displaceable manner between a regulation position where the bottom part of the fixing part 96 enters any one of the groove parts and a release position where the bottom part of the fixing part 96 does not enter any one of the groove parts. A knob protruding in the +Y direction is formed on the +Y side of the fixing part 96, and the user can select the regulation position or the release position by operating the knob. The fixing parts 96 are disposed on the +Y side of the main bodies of the first regulating part 91 and the second regulating part 92, and are held by the main bodies of the first regulating part 91 and the second regulating part 92 so as to be movable in the Z-axis direction. With this configuration, the first regulating part 91 and the second regulating part 92 can be fixed to the placement part 9 after the user adjusts the position of one or both of the first regulating part 91 and the second regulating part 92.

A third detection unit 913 that detects that the first regulating part 91 and the second regulating part 92 are fixed to the placement part 9 by the fixing parts 96 is disposed in the first regulating part 91 and the second regulating part 92. The third detection unit 913 uses a photosensor to detect whether the bottom part of the fixing part 96 enters the engaging part 9M. The third detection unit 913 is not limited to the photosensor, and a magnet sensor, a cantilever sensor, or the like may be used.

The control unit 4 causes the display unit 30 to display the fixing state of the fixing part 96, based on the detection result of the third detector 913. With this configuration, since it can be detected that the first regulating part 91 is fixed to the placement part 9 by the fixing part 96, the user can know the fixing state of the first regulating part 91 and the second regulating part 92.

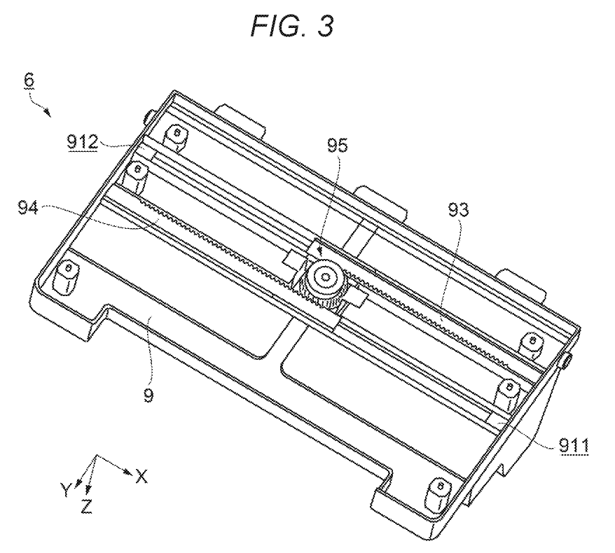

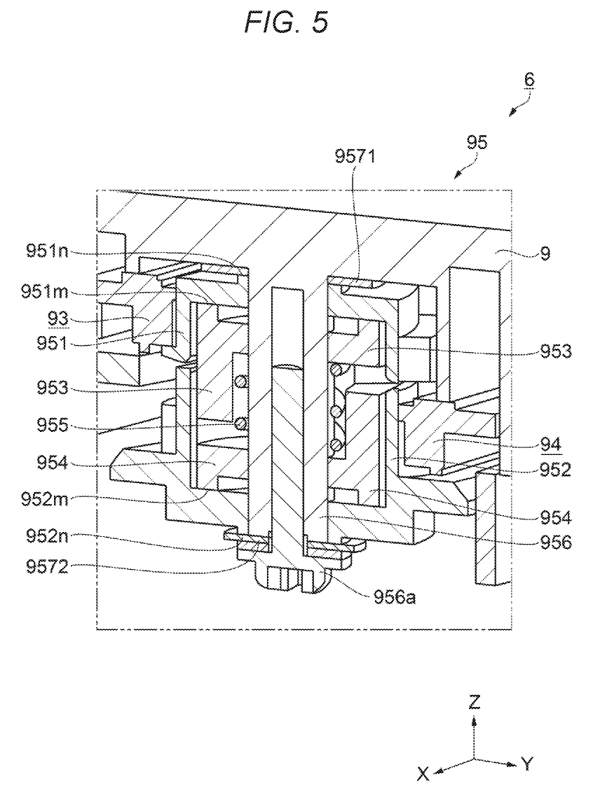

As shown in FIGS. 3 and 5, the interlocking mechanism 95 includes a first rack part 93, a second rack part 94, a first pinion gear 951, a second pinion gear 952, a first rotating part 953, a second rotating part 954, and an energizing part 955. The first rack part 93 is coupled to the first regulating part 91 and moves the first regulating part 91. The second rack part 94 is coupled to the second regulating part 92 and moves the second regulating part 92. The first pinion gear 951 is a gear that meshes with the first rack part 93, and the second pinion gear 952 is a gear that meshes with the second rack part 94. The first rack part 93 and the first pinion gear 951, and the second rack part 94 and the second pinion gear 952 each function as a rack-and-pinion mechanism.

The first rack part 93 and the second rack part 94 are disposed at the lower surface of the placement part 9 and extend along the X-axis direction. A plurality of teeth meshing with the first pinion gear 951 are formed along the X-axis direction on the +Y-side surface of the first rack part 93. A plurality of teeth meshing with the second pinion gear 952 are formed along the X-axis direction on the -Y-side surface of the second rack part 94.

The +X-side end part of the first rack part 93 is coupled to the bottom part of the first regulating part 91 in the elongated hole. The -X-side end part of the second rack part 94 is coupled to the bottom part of the second regulating part 92 in the elongated hole.

A cylindrical support part 956 extending in the -Z direction is formed at the lower surface of the placement part 9. The first pinion gear 951, the first rotating part 953, the energizing part 955, the second rotating part 954, and the second pinion gear 952 are disposed at the support part 956 in this order from the +Z side. A cap 956a having a larger outer diameter than the support part 956 is provided at the distal end of the support part 956, and the first pinion gear 951, the first rotating part 953, the energizing part 955, the second rotating part 954, and the second pinion gear 952 are rotatably supported by the support part 956 and the cap 956a.

A first contact part 9571 is disposed between the lower surface of the placement part 9 and the first pinion gear 951. A second contact part 9572 is disposed between the second pinion gear 952 and the cap 956a. The first contact part 9571 and the second contact part 9572 are, for example, flat washers of stainless steel having an annular appearance. As the first contact part 9571 and the second contact part 9572, iron, nylon, ABS resin, polyacetal (POM) resin, or the like may be used in addition to stainless steel.

The first pinion gear 951 rotates about the support part 956. That is, the first pinion gear 951 rotates around the rotation axis along the Z-axis direction. A plurality of teeth that mesh with the teeth of the first rack part 93 are formed at the outer peripheral surface of the first pinion gear 951. A recess that opens in the -Z direction is formed in the first pinion gear 951, and the first rotating part 953, described later, is stored in the recess. Also, the second pinion gear 952 rotates about the support part 956. That is, the second pinion gear 952 rotates around the rotation axis along the Z-axis direction. A plurality of teeth that mesh with the teeth of the second rack part 94 are formed at the outer peripheral surface of the second pinion gear 952. A recess that opens in the +Z direction is formed in the second pinion gear 952, and the second rotating part 954, described later, is stored in the recess.

In the present embodiment, the first pinion gear 951 and the second pinion gear 952 are arranged in the Z-axis direction. Specifically, the second pinion gear 952 is disposed on the -Z direction side of the first pinion gear 951. The Z-axis direction is an example of a first direction. However, the direction in which the first pinion gear 951 and the second pinion gear 952 are arranged is not limited to the Z-axis direction, and the first pinion gear 951 and the second pinion gear 952 may be arranged in the horizontal direction, for example.

The first pinion gear 951 has a first surface 951n extending along an X-Y plane and in contact with the first contact part 9571, and a second surface 951m extending along the X-Y plane and in contact with the first rotating part 953. The second pinion gear 952 has a third surface 952m extending along the X-Y plane and in contact with the second rotating part 954, and a fourth surface 952n extending along the X-Y plane and in contact with the second contact part 9572.

The material of the first pinion gear 951 and the second pinion gear 952 is preferably polyacetal (POM) resin in view of lubricity and wear resistance. Also, an acrylic resin may be used as well as an ABS resin and a phenol resin.

The first rotating part 953 is located between the first pinion gear 951 and the energizing part 955 in the Z-axis direction and is rotatable together with the energizing part 955. The second rotating part 954 is located between the second pinion gear 952 and the energizing part 955 in the Z-axis direction and is rotatable together with the energizing part 955.

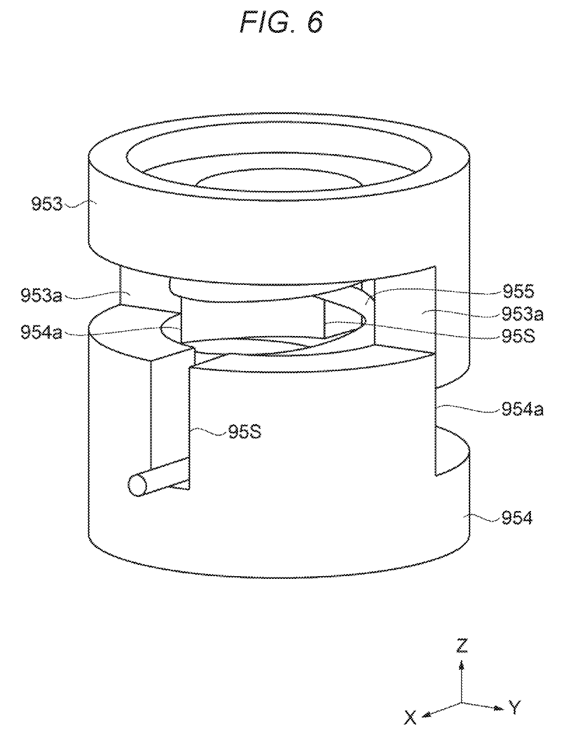

As shown in FIG. 6, the first rotating part 953 and the second rotating part 954 are formed of members having the same shape and are arranged facing different directions. Since the first rotating part 953 and the second rotating part 954 have the same shape, the cost of the medium loading device 6 can be reduced. The first rotating part 953 and the second rotating part 954 are substantially circular tube-like members, and a through hole through which the support part 956 is inserted is formed along the Z axis at the center of the first rotating part 953 and the second rotating part 954. The first rotating part 953 and the second rotating part 954 have an annular part having a circular cross section when cut in a direction intersecting the Z axis, and a cutout part having a semicircular cross section. The first rotating part 953 is disposed such that the cutout part is located on the -Z side of the annular part, and the second rotating part 954 is disposed such that the cutout part is located on the +Z side of the annular part.

Two transmitting surfaces parallel to the Z-axis direction are formed in the cutout part. Specifically, two first rotation transmitting surfaces 953a are formed in the cutout part of the first rotating part 953, and two second rotation transmitting surfaces 954a are formed in the cutout part of the second rotating part 954. That is, the first rotating part 953 has two first rotation transmitting surfaces 953a, and the second rotating part 954 has two second rotation transmitting surfaces 954a. The first rotating part 953 and the second rotating part 954 are disposed such that the first rotation transmitting surfaces 953a and the second rotation transmitting surfaces 954a face each other and abut on each other. With this configuration, since the first rotating part 953 and the second rotating part 954 are in contact with each other via the plurality of rotation transmitting surfaces, these rotating parts can be rotated in a unified manner.

The diameter of the through hole in the cutout part is larger than the diameter of the through hole in the annular part. The energizing part 955 is disposed in the through hole in the cutout part so as to extend over the first rotating part 953 and the second rotating part 954.

The material of the first rotating part 953 and the second rotating part 954 is preferably a polyacetal (POM) resin in view of lubricity and wear resistance. Also, an acrylic resin may be used as well as an ABS resin and a phenol resin.

The energizing part 955 is a coil-shaped spring. Specifically, the energizing part 955 is a compression coil spring formed of alloy steel. The energizing part 955 energizes the first pinion gear 951 and the second pinion gear 952 in directions away from each other along the Z-axis direction via the first rotating part 953 and the second rotating part 954. The energizing part 955 is not limited to a coil-shaped spring, and may be an elastomer, a magnetic spring, or the like.

A slit part 95S is formed in the first rotating part 953 and the second rotating part 954. One end of the energizing part 955 enters the slit part 95S of the first rotating part 953, and the other end of the energizing part 955 enters the slit part 95S of the second rotating part 954. Therefore, the energizing part 955 is fixed to the first rotating part 953 and the second rotating part 954 with respect to the rotation direction around the Z axis, and can rotate around the Z axis integrally with the first rotating part 953 and the second rotating part 954.

The frictional force generated on the first surface 951n where the first pinion gear 951 and the first contact part 9571 are in contact with each other is generated based on the contact radius between the first pinion gear 951 and the first contact part 9571. The frictional force generated on the fourth surface 952n where the second pinion gear 952 and the second contact part 9572 are in contact with each other is generated based on the contact radius between the second pinion gear 952 and the second contact part 9572.

The frictional force generated on the second surface 951m where the first pinion gear 951 and the first rotating part 953 are in contact with each other is generated based on the contact radius between the first pinion gear 951 and the first rotating part 953. The frictional force generated on the third surface 952m where the second pinion gear 952 and the second rotating part 954 are in contact with each other is generated based on the contact radius between the second pinion gear 952 and the second rotating part 954. The frictional force generated between the first pinion gear 951 and the first contact part 9571 and the frictional force generated between the second pinion gear 952 and the second contact part 9572 are smaller than the frictional force generated between the first pinion gear 951 and the first rotating part 953 and the frictional force generated between the second pinion gear 952 and the second rotating part 954.

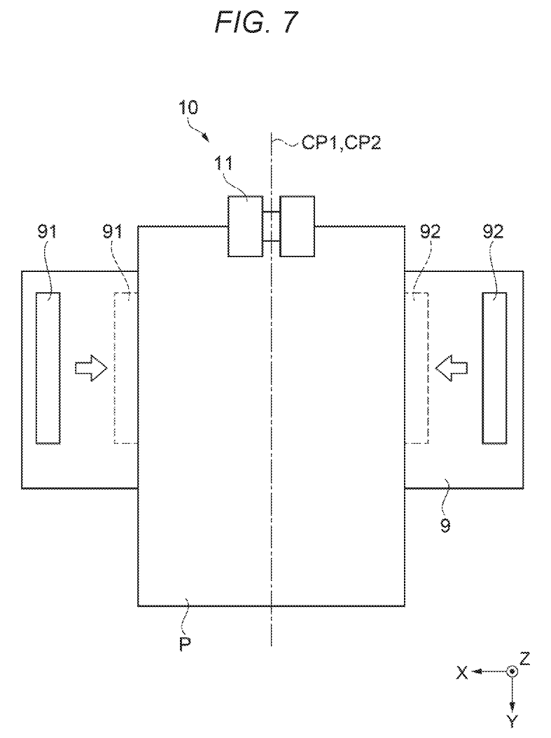

An operation of the interlocking mechanism 95 when the user performs an operation of moving one of the first regulating part 91 and the second regulating part 92 in the width direction will be described. As illustrated in FIG. 7, this operation is performed, for example, when one medium P is placed on the placement part 9 or when a plurality of media P having the same width are loaded on the placement part 9.

When a bundle of media P having the same width is placed on the placement part 9, the user operates one of the first regulating part 91 and the second regulating part 92 so that the placed media P are laid along the first regulating part 91 and the second regulating part 92. The energizing part 955 forming the interlocking mechanism 95 energizes the first pinion gear 951 and the second pinion gear 952 in directions away from each other along the Z-axis direction via the first rotating part 953 and the second rotating part 954. Therefore, the frictional force generated on the second surface 951m and the third surface 952m when the first pinion gear 951 or the second pinion gear 952 rotates is larger than when the first pinion gear 951 and the second pinion gear 952 are not energized. Thus, the first pinion gear 951, the first rotating part 953, the energizing part 955, the second rotating part 954, and the second pinion gear 952 rotate in a unified manner. Therefore, for example, when the user moves the first regulating part 91 along the +X axis, which is the width direction, the movement of the first regulating part 91 rotates the first pinion gear 951 and the second pinion gear 952 via the first rack part 93 coupled to the first regulating part 91. The rotation of the second pinion gear 952 is transmitted to the second rack part 94 meshing with the second pinion gear 952, and moves the second regulating part 92 coupled to the second rack part 94 along the -X axis, which is the width direction. At this time, when viewed from the feeding direction, a center position CP1 between the first regulating part 91 and the second regulating part 92 and a center position CP2 of the pick roller 11 overlap each other.

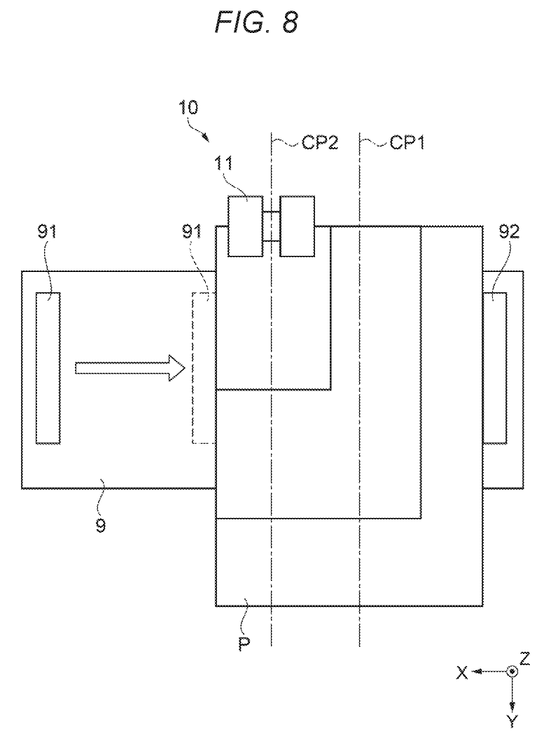

Next, a case where the user restricts the movement of one of the first regulating part 91 and the second regulating part 92 and moves the other will be described. This operation is performed, for example, when a plurality of media P having different widths are loaded on the placement part 9 (as illustrated in FIG. 8).

When a plurality of media P having different widths are placed on the placement part 9, the user adjusts the position of the media P in the width direction such that all the placed media P are laid along the first regulating part 91 or the second regulating part 92 and all the placed media P are fed by the pick roller 11. In this case, the user restricts the movement of one of the first regulating part 91 and the second regulating part 92 and moves the other. At this time, when viewed from the feeding direction, the pick roller 11 is located between the first regulating part 91 and the second regulating part 92, and the center position CP1 between the first regulating part 91 and the second regulating part 92 in contact with the medium P and the center position CP2 of the pick roller 11 do not overlap each other.

For example, when the movement of the second regulating part 92 is restricted and the first regulating part 91 is moved in the width direction, the second regulating part 92 and the second rack part 94 coupled to the second regulating part 92 do not operate, and the second pinion gear 952 meshing with the second rack part 94 does not rotate. That is, when the second regulating part 92 is fixed and the first regulating part 91 is moved in the width direction, the second pinion gear 952 stops and the first pinion gear 951 rotates. The first rotating part 953, the second rotating part 954, and the energizing part 955 rotate or stop in a unified manner. Whether the first rotating part 953, the second rotating part 954, and the energizing part 955 rotate or stop is determined, based on the relationship between the magnitude of the frictional force on the second surface 951m and the magnitude of the frictional force on the third surface 952m. For example, when the frictional force on the second surface 951m is greater than the frictional force on the third surface 952m, the first rotating part 953, the second rotating part 954, and the energizing part 955 rotate together with the first pinion gear 951. Meanwhile, when the frictional force on the second surface 951m is smaller than the frictional force on the third surface 952m, the first rotating part 953, the second rotating part 954, and the energizing part 955 stop together with the second pinion gear 952. With this configuration, the first rotating part 953, the second rotating part 954, and the energizing part 955 rotate or stop in a unified manner. Therefore, when the first regulating part 91 is moved in a state where the second regulating part 92 is fixed, the user can easily move the first regulating part 91 to a desired position. When the first regulating part 91 is fixed and the second regulating part 92 is moved in the width direction, the first pinion gear 951 stops and the second pinion gear 952 rotates. The first rotating part 953, the second rotating part 954, and the energizing part 955 rotate or stop in a unified manner.

In the above embodiment, an example in which the feeding device 2 is incorporated in the image reading device 1 is described, but the feeding device 2 may be incorporated in an device other than the image reading device 1. For example, the feeding device 2 may be incorporated in an image forming device including a recording unit that performs recording on the medium P fed by the feeding device 2, and may be used as a feeding mechanism of the image forming device.

What is claimed is:

1. A medium loading device comprising:
a placement part where a medium is placed;
a first regulating part and a second regulating part configured to be able to adjust a position of the medium placed on the placement part in a width direction intersecting a feeding direction of the medium; and
an interlocking mechanism configured to move the first regulating part and the second regulating part in an interlocking manner, wherein
the interlocking mechanism includes:
a first rack part coupled to the first regulating part;
a second rack part coupled to the second regulating part;
a first pinion gear meshing with the first rack part;
a second pinion gear disposed in a first direction of the first pinion gear and meshing with the second rack part;
an energizing part configured to energize the first pinion gear and the second pinion gear in a direction away from each other along the first direction;
a first rotating part located between the first pinion gear and the energizing part in the first direction and configured to be rotatable together with the energizing part; and
a second rotating part located between the second pinion gear and the energizing part in the first direction and configured to be rotatable together with the energizing part, and
when the second regulating part is fixed and the first regulating part is moved in the width direction, the second pinion gear stops, the first pinion gear rotates, and the first rotating part, the second rotating part, and the energizing part rotate or stop in a unified manner.

2. The medium loading device according to claim 1, wherein
the first rotating part has at least two first rotation transmitting surfaces that come into contact with the second rotating part, and
the second rotating part has at least two second rotation transmitting surfaces that come into contact with the first rotation transmitting surfaces.

3. The medium loading device according to claim 2, wherein
the first rotating part and the second rotating part have the same shape.

4. The medium loading device according to claim 1, wherein
the energizing part is a coil-shaped spring,
the first rotating part and the second rotating part have a slit part,
one end of the spring enters the slit part of the first rotating part, and
the other end of the spring enters the slit part of the second rotating part.

5. The medium loading device according to claim 1, comprising:
a display unit configured to perform display;
a control unit;
a first detection unit configured to detect a position of the first regulating part; and
a second detection unit configured to detect a position of the second regulating part, wherein
the control unit determines a size of the loaded medium, based on detection results of the first detection unit and the second detection unit, and causes the display unit to display the size.

6. The medium loading device according to claim 1, wherein
the first regulating part and the second regulating part include a fixing part that fixes the first regulating part and the second regulating part to the placement part,
a groove part is formed in the placement part, and
the fixing part is displaceable between a regulation position where the fixing part enters the groove part and a release position where the fixing part does not enter the groove part.

7. The medium loading device according to claim 6, comprising:
a third detection unit configured to detect that the first regulating part is fixed by the fixing part.

8. A feeding device comprising:
the medium loading device according to claim 1; and
a feeding unit configured to feed the medium loaded in the medium loading device, wherein
when viewed from the feeding direction,
the feeding unit is located between the first regulating part and the second regulating part, and
a center position between the first regulating part and the second regulating part in contact with the medium and a center position of the feeding unit do not overlap each other.

9. An image reading device comprising:
the feeding device according to claim 8; and
a reading unit configured to read an image on the medium fed by the feeding device.

10. An image forming device comprising:
the feeding device according to claim 8; and
a recording unit configured to perform recording on the medium fed by the feeding device.
